(19) United States
(12) Patent Application Publication
(10) Pub. No.: US 2006/0161667 A1
(43) Pub. Date: Jul. 20, 2006

(54) Server apparatus, communication control method and program

(76) Inventors: Kentaro Umesawa, Kanagawa-ken (JP); Toshinari Takahashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/317,074

(22) Filed: Dec. 27, 2005

(30) Foreign Application Priority Data
Dec. 27, 2004 (JP) 2004-378288

(51) Int. Cl. G06F 15/16; H04L 9/32

(52) U.S. Cl. 709/229; 726/4

(57) ABSTRACT

A server computer and a client computer determine a method of storing user identification information into a connection request packet therebetween. When establishing a connection with the server computer, the client computer stores its own user identification information in a server application into a connection request packet and transmits it. The server computer extracts the converted user identification information, and refers to a task storage table of the application based on the user identification information, and in the case where the task exists, the server computer transmits a connection request acknowledgement packet and establishes the connection.

### CROSS-REFERENCE TO RELATED APPLICATIONS

This application is based upon and claims the benefit of priority from the prior Japanese Patent Application No. 2004-378288, filed on Dec. 27, 2004; the entire contents of which are incorporated herein by reference.

### DESCRIPTION OF RELATED ART

The present invention relates to a server apparatus to provide a service to a client apparatus through a connection, a communication control method relating to establishment of the connection, and a program.

In recent years, client/server systems have been widely used on the Internet and other networks. One or more client computers are connected to a server computer through a packet exchange network, which supplies data from the server computer in response to requests from the client computers. Here, the packet means a segment of data flowing on a network, and is roughly composed of a header including a start IP (Internet Protocol) address, an end IP address and the like, and a data body.

In a client/server system, a server application program (hereinafter referred to as a server application) operating on the server computer provides a service to a client application program (hereinafter referred to as a client application) operating on the client computer. When the client connects to the server, the server application identifies (that is, acquires user identification information) the user on the client computer requesting the connection, confirms the presence or absence, i.e., availability, of the type of processing being requested (hereinafter referred to as a task), and provides the service in the case where the task is available.

In this system, after the connection is established between the server computer and the client computer, the user identification information is acquired by the server, and the availability of the task on the server is confirmed. Because the connection must be established before the server can acquire the user identification information, the system is vulnerable to a DoS attack (Denial of Service attack), a DDoS attack (Distributed Denial of Service attack), or attacks that target server applications before the server can acquire the user identification.

Although JP-A-2003-91504 discloses a technique to speed up the authentication of a user ID and a password to the access from the user, the technique can not solve the problem of the security described above.

### BRIEF SUMMARY OF THE INVENTION

Consistent with the present invention, there is provided, a server apparatus comprising: a processor configured to execute a task for providing a service to a client apparatus through a connection established on a network; a storage unit configured to store task information which indicates the availability of a task to be executed by the processor, corresponding to user identification information relating to the client apparatus; a reception unit configured to receive a connection request packet from the client apparatus; a first acquisition unit configured to acquire the user identification information from the received connection request packet; a second acquisition unit configured to acquire the task information in the storage unit based on the acquired user identification information; a determination unit configured to determine, based on at least the acquired task information, whether a connection request by the connection request packet is allowed; and a transmission unit to transmit a packet to establish the connection in a case where it is determined that the connection request is allowed.

Also consistent with the present invention, there is provided a server operating method, comprising: executing a task for providing a service to a client apparatus through a connection established on a network; storing in a storage unit mask information which indicates the availability of a task to be executed corresponding to user identification information relating to the client apparatus; receiving a connection request packet from the client apparatus; acquiring the user identification information from the received connection request packet; acquiring the task information in the storage unit based on the acquired user identification information; determining, based on at least the acquired task information, whether a connection request by the connection request packet is allowed; and transmitting a packet to establish the connection in a case where it is determined that the connection request is allowed.

Further consistent with the present invention, there is provided a computer program computed on a server apparatus, the computer program having a plurality of instructions that cause a processor to perform the following steps: executing a task for providing a service to a client apparatus through a connection established on a network; storing in a storage unit mask information which indicates the availability of a task to be executed corresponding to user identification information relating to the client apparatus; receiving a connection request packet from the client apparatus; acquiring the user identification information from the received connection request packet; acquiring the task information in the storage unit based on the acquired user identification information; determining, based on at least the acquired task information, whether a connection request by the connection request packet is allowed; and transmitting a packet to establish the connection in a case where it is determined that the connection request is allowed.

### BRIEF DESCRIPTION OF THE SEVERAL VIEWS OF THE DRAWINGS

FIG. 1 is a diagram showing an example of a communication system according to one embodiment.

FIG. 2 is a diagram of an IP packet.

FIG. 3 is a diagram of a TCP segment.

FIG. 4 is a diagram of a UDP segment.

FIG. 5 is a diagram showing a structural example of a client computer according to the embodiment.

FIG. 6 is a diagram showing a structural example of a server computer according to the embodiment.

FIG. 7 is an example of a storage unit, provided as a task storage table, according to the embodiment.

FIG. 8 is a flowchart showing an example of a processing procedure of a client computer according to a first system structural example.

FIG. 9 is a flowchart showing an example of a processing procedure of a server computer according to the first system structural example.

FIG. 10 is a table showing an example of a server policy storage table according to a second system structural example (and a third system structural example).

FIG. 11 is a flowchart showing an example of a processing procedure of a server computer according to the second system structural example.

FIG. 12 is a flowchart showing an example of a processing procedure of a server computer according to the third system structural example.

FIG. 13 is an example of a policy storage unit, provided as a user operation mode policy storage table according to a fourth system structural example.

FIG. 14 is a flowchart showing an example of a processing procedure of a client computer according to the fourth system structural example.

FIG. 15 is a flowchart showing an example of a processing procedure of a server computer according to the fourth system structural example.

### DETAILED DESCRIPTION OF THE EMBODIMENTS

Hereinafter, an embodiment of the invention will be described with reference to the drawings.

In this embodiment, a description will be given of a client/server system in which when a server application operating on a server computer provides a service to a client application operating on a client computer, the server application acquires user identification information of a connection requester (a user of the client application operating), i.e., a user on the client computer requesting the connection, confirms the presence or absence, i.e., availability, of the type of processing (task) to be performed by the server application for the identified partner, and provides the service if the task is available.

As described before, the user requesting the connection is the user of the client application operating on the client computer that sent the request. The user identification is the information used by the server application to uniquely identify the user requesting the connection.

Using the user identification to confirm the availability of a task is widely used. For example, in delivery of electronic mail, the server uses the user identification to determine whether the user has received new email. If a new email has arrived, a delivery task is available to run on the server, and this result is confirmed to the client. Another example is a remote control system for networked home appliances using a relay server. In this example, a DVD player could poll the relay server for the availability of a recording task. If a user has requested that a program be recorded, by a cell phone or other means, the recording task is available on the relay server, and the program will be recorded. In this type of system, the user requesting the connection to the client computer to execute the client application can receive the service when the task is available for that user.

As an example, a description will be given of a case in which communication between the server computer and the client computer is performed by TCP/IP (Transmission Control Protocol/IP).

Here, a problem in a conventional client/server system will be described in detail.

Conventionally, the confirmation of the availability of a task is performed as follows.

(1) In response to a task confirmation request from the client application, the connection is established between the server computer and the client computer. By establishing the connection, the processing of the server application is started in response to the request of the client application.

(2) The client application uses the established connection to transmit the user identification (information used by the server application to identify the user requesting the connection) to the server application.

(3) The server application uses, as a search key, the user identification received in the connection established in (1), and searches a storage unit (hereinafter referred to as a task storage table) in which the user identification is used to determine availability of a task.

(4) If the task is available, the task is performed, and in the case where the task does not exist, the server application disconnects from the client application.

Alternately, the client application can have a copy of the task storage table, so the client can use the user identification and the task storage table to confirm the availability of a task. In this case it is not necessary for the server application to notify the client application each time the availability of the task changes. This has the benefit of allowing the user requesting the connection to confirm the availability of a task even if a connection cannot be established.

In the conventional system described above in items (1) to (4), the server does not acquire the user identification until after the connection is established between the server computer and the client computer. Only then is the availability of the task is confirmed. Even if the server has no task available for this user, the connection has been established. This can cause several types of security problems, such as a vulnerable server application, a DoS attack (Denial of Service attack) or a DDoS attack (Distributed Denial of Service attack).

(1) Vulnerability of Server Application can be Attacked:

A server application may have a vulnerability that is exploitable by a client application that can connect to the server application. The attacker first establishes a connection, and transmits data to attack the application vulnerability through the established connection. Even if the server application has an authentication function, and data exchanges with unauthenticated clients are limited, there is a possibility that the application vulnerability exists in the authentication portion itself. For example, in the SSH (Secure Shell) protocol for safe remote operation of a computer over the Internet, or SSL (Secure Sockets Layer) for ensuring safe Web browsing and information transmission, the application vulnerability is often found in the authentication portion of the application. These attacks are only successful if a TCP connection is established between the application and the attacker.

(2) Server Resources can be Attacked by Establishing a Large Number of Connections:

The possibility of DoS attacks (Denial of Service attack) exists where a client establishes a large number of connections, so that the connection processing resources of the server computer are exhausted. Here, the DoS attack means that the resource, meant to be used by a legitimate client, is exhausted by the attacking client, or the resources are otherwise compromised and can be hacked to prevent the legal client from using the resource. The DDoS attack is the DoS attack performed by multiple client computers. Such attacks become more problematic when the server application, like SSH or SSL, uses an encryption scheme, as these schemes increase processing requirements on the server.

As stated above, security problems are caused by allowing indiscriminate establishment of connections. It is therefore desirable to avoid establishing unnecessary connections. In general, this security problem can be solved by controlling the establishment of the TCP connection in the TCP layer and the IP layer of the TCP/IP protocol. This technique improves the security of the server.

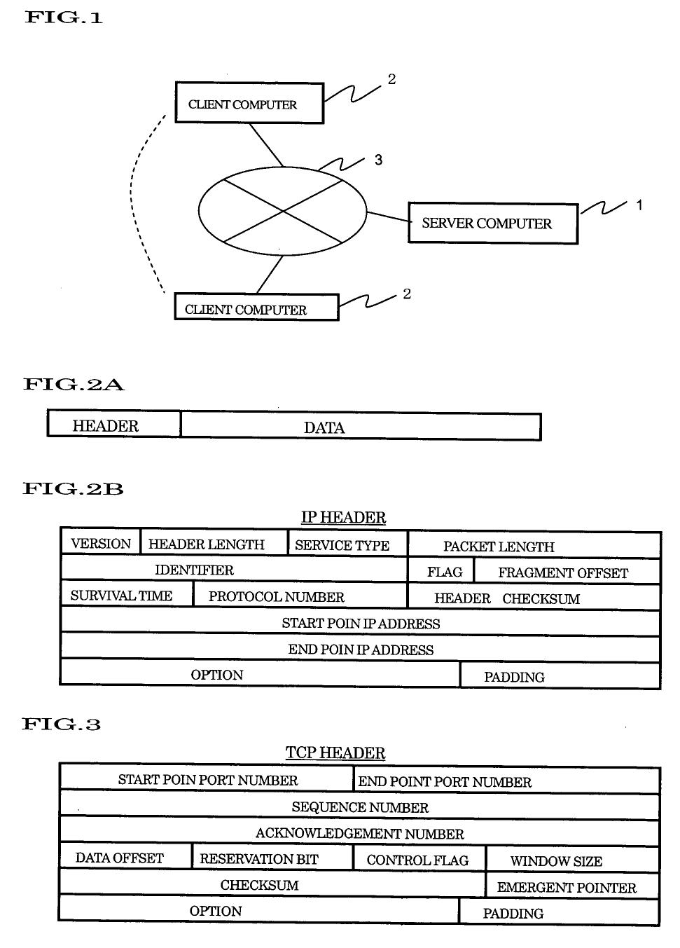

FIG. 1 shows a structural example of a communication system according to an embodiment of the invention.

FIG. 1 shows the example in which one server computer (server apparatus) 1 and multiple client computers (client apparatuses) 2 exist, and they are connected through various communication networks 3 including an open network such as the Internet and dedicated lines connected thereto. In FIG. 1, although only one server computer 1 is shown, two or more server computers 1 may naturally exist. While each server computer 1 may be an apparatus other than a general-purpose computer having a server function, and the client computer may be an apparatus (for example, a cellular phone, a network home electric appliance, etc.) other than a general-purpose computer having a client function, the following description will use the terms client computer and server computer.

As described before, the case where the communication between the server computer 1 and the client computer 2 is performed by TCP/IP is used as an example. TCP/IP layers, from lower to higher, include a network access layer, a network layer, a transport layer and an application layer

The network access layer corresponds to a combination of the physical layer of the OSI (Open Systems Interconnection) reference model and the data link layer, and is a processing layer which enables the transmission/reception of data by an electric signal or an optical signal and the control required to adjust the flow of information between adjacent nodes.

The network (Internet) layer corresponds to the network layer of the OSI reference model, and is a processing layer which takes charge of the routing of data between networks and data distribution to the computer for communication.

The transport layer is almost equivalent to the transport layer of the OSI reference model, and is a processing layer which provides a distribution service to a specified application layer port and an error check function of data. In the transport layer, the protocols of TCP (Transmission Control Protocol) and UDP (User Datagram Protocol) can be used. As described later, in TCP, a connection-based environment is provided and ensures the arrival of data. On the other hand, the UDP provides a connectionless environment and does not ensure the arrival of data.

The application layer is equivalent to the application layer of the OSI reference model, and is a processing layer that performs communication processing control by which an application performs data transmission/reception and application-specific processing.

The communication in layers above the network layer is performed with an IP packet.

FIG. 2 shows a structure of a general IP packet.

As shown in FIG. 2A, the IP packet includes an IP header part and a data part.

As shown in FIG. 2B, the IP header part includes various pieces of information, including “version” to indicate the version (IPv4, IPv6, etc.) of IP, “header length” to indicate the header length of the IP header part, “service type” to instruct a router about the type of communication service, “packet length” to indicate the length (packet length) of the whole IP packet, “identifier” as a sequence number if the packet has been fragmented, “flag” to control fragmentation processing, “fragment offset” to indicate position if the packet has been fragmented, “survival time” to indicate the number of routers the packet can pass through without being discarded, “protocol number” to indicate the protocol of the upper layer (for example, ICMP is 1, TCP is 6, UDP is 17), “header checksum” to ensure that data is not corrupted, “start point IP address” to indicate the IP address of the transmission source, “end IP address” to indicate the IP address of the destination, “option” to use various option functions, and “padding” to make an adjustment so that the header length of the IP header becomes a multiple of 32 bits.

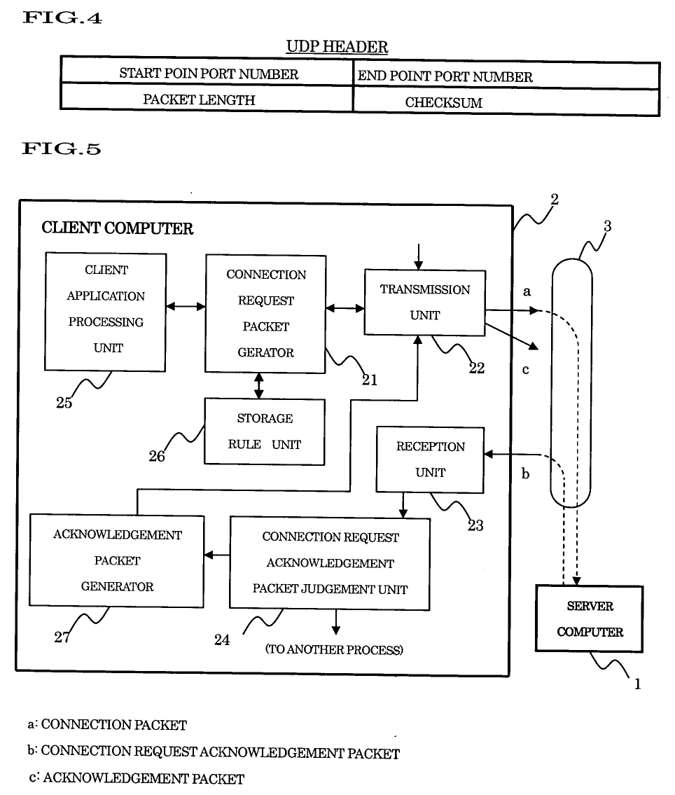

The data part includes a segment of TCP, UDP or ICMP data. FIG. 3 shows the structure of a header of a general TCP segment. The TCP segment includes the TCP header and a data portion.

The TCP header includes various pieces of information of “start point port number” to indicate the port number of the transmission source, “end point port number” to indicate the port number of the transmission destination, “sequence number” to indicate the position of transmitted data, “acknowledgement number” to indicate the position of received data, “data offset” to indicate the start position of data carried by TCP, “reservation bit” for expansion, “control flag” to indicate the type of processing to be performed on the TCP packet, “window size” which is used for flow control and indicates the length of receivable data, “checksum” to ensure that data is not corrupted, “urgent pointer” to indicate the position of data to be processed urgently, “option” used for improvement of communication performance by TCP, and “padding” to ensure the header size is a multiple of 32 bits.

FIG. 4 shows a structure of a header of a general UDP segment. The UDP segment includes the UDP header and a data portion.

The UDP header includes various pieces of information including “start port number” to indicate the port number of the transmission source, “end point port number” to indicate the port number of the transmission destination, “packet length” to indicate the length of the UDP segment, and “checksum” to ensure that the UDP header, IP address and protocol number are not corrupted.

Following is an example of a correct access request in the TCP/IP protocol:

(1) a client computer transmits a connection request packet (SYN (SYNchronize) packet) to a server computer,

(2) the server computer transmits a connection request acknowledgement packet (SYN+ACK (ACKnowledgement) packet) to the client computer, and

(3) the client computer transmits an acknowledgement (ACK) packet to the server computer, a logical communication channel (connection) is established between the computers, and transmission/reception of data using a higher-level application is performed in the connected state. This access request scheme is called a three-way handshake scheme.

Logical port numbers up to 65535 can be used. Other types of packets for connection control exist in TCP, including a URG packet (to indicate urgent information), a PHS packet (to indicate that it is necessary for a receiver to quickly deliver the data of this packet to an application), an RST packet (to reset connection), an FIN packet (to notify that a sender has ended transmission of data), and others.

Since UDP and ICMP are connectionless communication protocols, the connection establishment as stated above is not performed, and the transmission/reception of data is performed without a connection.

FIG. 5 shows a structural example of the client computer 2 according to one embodiment of the invention. FIG. 5 shows a functional diagram of the portion of the client relating to connection control, including a confirmation procedure.

As shown in FIG. 5, the client computer 2 includes a connection request packet generator 21, a transmission unit 22, a reception unit 23, a packet assessment unit 24, a client application processing unit 25, a storage rule table 26, and an acknowledgement packet generator 27.

The client application processing unit 25 is a processing unit functioning on the client and interacting with the server application. When the connection to the server application is made, the user identification to be shared with the server application is sent to the connection request packet generator 21. The user identification stored in the client application may be used, it may be requested from the user executing the client application each time a connection is requested, or another method may be adopted for gathering the user identification.

When the connection request packet generator 21 receives an instruction to perform a connection request from a client application, so that the client application can ascertain the availability of a task on the server, the connection request packet generator 21 creates a connection request packet. The packet generator 21 stores the user identification in the packet based on the storage rule table 26.

The transmission unit 22 is for transmitting an IP packet to the network 3. It sequentially transmits the respective connection request packets generated by the connection request packet generator 21 to the network 3, and transmits other packets as well.

The reception unit 23 receives the IP packet from the network 3. The received IP packet is sent to the packet assessment unit 24.

The packet assessment unit 24 determines whether this IP packet is a connection request acknowledgement packet from the server computer 1, in response to any one of the connection request packets transmitted from the transmission unit 22. If this assessment indicates that the IP packet is a connection request acknowledge packet corresponding to one of the connection requests, this means that a task for the user requesting the connection is available on the server application of the server computer 1. The connection request acknowledgement packet is delivered to the acknowledgement packet generator 27, and other packets are delivered to a suitable processing unit.

If the IP packet is assessed to be a corresponding connection request acknowledgement packet, the acknowledgement packet generator 27 performs connection control to establish a connection to the server computer 1. The acknowledgement packet is generated, and this is sent to the server computer 1 through the transmission unit 22.

Here, the storage rule table 26 will be described in detail.

The storage rule table 26 is a table describing rules for storing the user identification into the connection request packet. The storage rule table 26 is previously shared between the client computer 2 and the server computer 1.

With storage rule, there is a method of using a connection request packet to directly store the user identification information in such a manner that one connection request packet is generated, and a value is embedded by using a specific packet header field (option field, sequence number field, etc.), or the value is embedded in the payload portion of the packet. Alternately, multiple connection request packets are generated, and the user identification information is divided and is embedded in a specific header field (more information can be embedded this way, and as compared with the method of using the payload, larger packet sizes can be avoided). Another method is conceivable in which multiple connection request packets are used, and the user identification information is expressed by the number of packets, a time interval between packets, or the like. With respect to the user identification information to be stored in the connection request packet, the user identification information can be stored unmodified, or a specific coding processing can be applied. The server computer 1 and client computer 2 can share a rule for converting the data embedded in the packet. As long as it is shared with the server computer 1, the conversion rule can be application-specific, specific to a group of applications, specific to the client or a group of clients, specific to each user identification information, or specific to groups of user identification information.

In addition to the user identification information, a password can be transmitted, or the user identification information can be converted and transmitted by an encryption processing using a previously shared encryption key. By doing so, it becomes possible to confirm that the transmitter of the connection request packet is a client computer of a trusted user requesting the connection, or maintain the confidentiality of the user identification information stored in the connection request packet.

It is desirable that the storage rule, and the user identification information (and the conversion rule and password in the case where the user identification information is protected, and also an encryption key in the case where encryption is performed) is secretly shared between the client computer 2 and the server computer 1. This can be realized by online processing using a channel secured by using an encryption protocol (using existing techniques such as SSL) or by offline sharing performed by mail or the like.

The client computer 2 used by the user requesting the connection may hold different storage rules corresponding to multiple server applications.

If the method for storing the user identification information into the connection request packet is fixed beforehand, this storage rule table can be omitted.

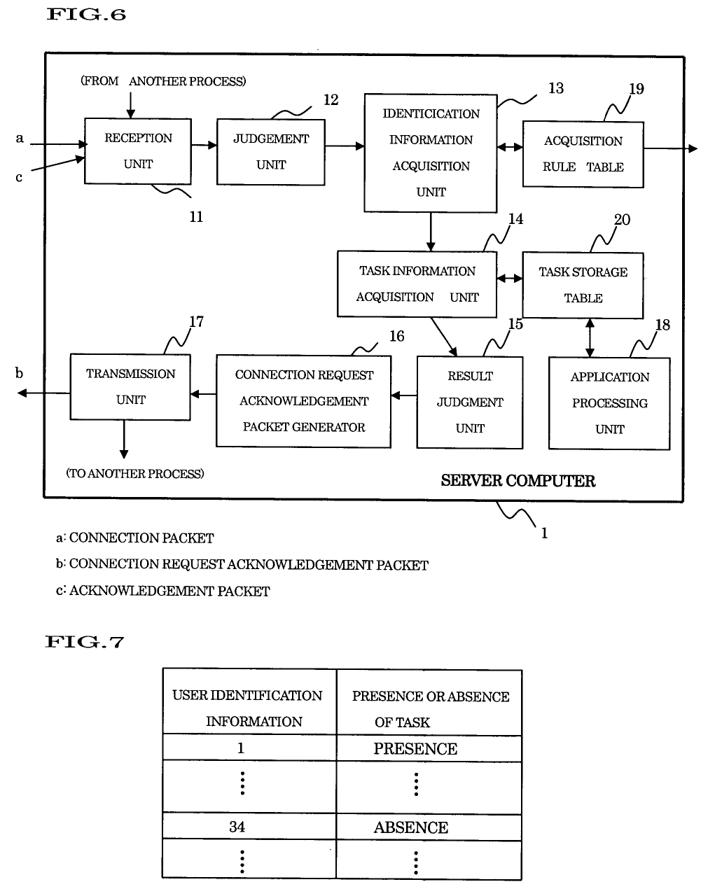

FIG. 6 shows a structural example of the server computer 1 according to one embodiment of the invention. FIG. 6 shows a functional diagram of the portion of the server relating to connection control, including a confirmation procedure.

As shown in FIG. 6, the server computer 1 includes a reception unit 11, an judgment unit 12, an identification information acquisition unit 13, a task information acquisition unit 14, a result judgment unit 15, a connection request acknowledgement packet generator 16, a transmission unit 17, a server application processing unit 18, an acquisition rule table 19, and a task storage table 20.

The task storage table 20 includes at least user identification information corresponding to the availability in the server application of a task. The task storage table 20 is accessed by the task information acquisition unit 14 and the application processing unit 18. At various times, the task storage table 20 records the availability of tasks in the application processing unit 18.

The server application processing unit 18 does processing based on the user identification information, and stores the task information relating to that user identification information into the task storage table 20. Although various server applications are envisioned, each application manages the task relating to the user identification information, and records the state of the task change into the task storage table 20 whenever necessary. For example, when the server application is an electronic mail storage server, the availability of new mail is stored in the task storage table 20. The availability information indicates, for each user, the availability of new mail since the last inquiry by that user. When e-mail arrives, the server application updates the task storage table 20, from indicating the delivery task is unavailable to indicating that the delivery task is available.

The reception unit 11 receives an IP packet from the network 3. The received IP packet is sent to the judgment unit 12.

The judgment unit 12 determines the packet destination based on the content of the IP packet received by the reception unit 11. If the received IP packet is a connection request packet, and the destination port number is that of the server application program, the packet is delivered to the identification information acquisition unit 13. Other packets are delivered to a suitable processing unit.

The identification information acquisition unit 13 uses the acquisition rule table 19 to acquire the user identification information from the connection request packet. The storage result table maps from the user or client who is requesting the connection to a rule. This rule specifies how the user identification information is stored in the packet for that particular client. This enables the acquisition unit to find the user identification information in the packet.

The task information acquisition unit 14 then searches the task storage table 20 based on the user identification information, and acquires the task information corresponding to the user identification information.

A determination unit, provided as a result judgment unit 15, confirms the availability of a task corresponding to this user identification information. It then makes a decision as to whether the connection to the client is allowed or not, and issues an instruction based on the result of this decision. If the task exists, the connection is allowed, and the result judgment unit instructs the connection request acknowledgement packet generator 16 to respond to the received connection request packet. If no task exists, the connection is not allowed, and no connection is made. As described in another version below, the server can choose to send a reply indicating refusal of the connection. As described in yet another version below, a decision based on a policy as to whether connection can be performed can also be used.

To establish a connection, the connection request acknowledgement packet generator 16 creates a connection request acknowledgement packet that corresponds to the received connection request packet. This step occurs if the decision from the result judgment unit 15 indicates that a connection should be established.

The transmission unit 17 is for transmitting the IP packet to the network 3. It transmits the connection request acknowledgement packet created by the connection request acknowledgement packet generator 16 to the network 3, and transmits other packets as well.

In the embodiment described above, the result judgment unit 15 instructs the connection request acknowledgement packet generator 16 only in the case where it is confirmed that the task exists. Alternately, when the task does not exist, the result judgment unit instructs the packet generator to send back a response packet indicating that the task does not exist in accordance with the instruction from the result judgment unit 15. The generator can then generate the response packet, and transmit the packet with the transmission unit 17.

The identification information acquisition unit 13 uses the acquisition rule table 19 to acquire the user identification information stored in the received connection request packet. Storage rules in this table indicate how the user identification information is stored in the connection request packet. Example storage rules are described above, including the case where encryption is used. The conversion rule shared between server computer 1 and client computer 2 details how to extract the user identification information from the connection request packet. The conversion rule itself may be specific to each application, each client, or each user's identification information, as long as it is shared with the client computer 2.

If the method for storing the user identification information into the connection request packet is fixed beforehand, this storage rule table can be omitted.

There is a case where the storage rules in the client computer 2 and the server computer 1 are the same. For example, if a value is embedded in a specific field of one connection request packet, the information indicating the specific field may be shared between the client and server.

Alternately, there is a case where the storage rules correspond to each other. If the values are dispersed and embedded in specific fields of multiple connection request packets, the client computer 2 may have a method of dispersing the user identification information into multiple packets. For example, the user identification information could be divided into two parts of an upper bit and a lower bit, the upper bit being embedded in a specific field of the first packet, and the lower bit being embedded in a specific field of the second packet. Then the server computer 1 has a method of restoring the values from the multiple packets. For example, a value is extracted from the specific field of the first packet, and this is made the upper bit of the user identification information, and a value is extracted from the specific field of the second packet, and this is made the lower bit of the user identification information, and the extracted values are connected in sequence to restore the user identification information.

With respect to the method in which the server computer 1 confirms the user identification information of the client computer 2, and the method of constructing the user identification information, various methods can be used.

In the following, each connection establishment control method is exemplified based on the structure described up to now, and the operation of the client computer 2 and the server computer 1 will be described.

(First System Structural Example)

First, a description will be given of an example where a task is retrieved by using only the user identification information, and connection control processing is performed.

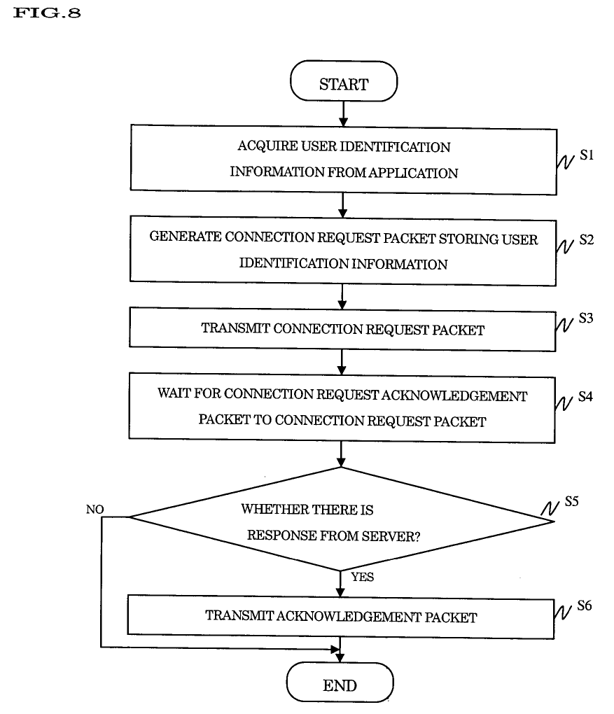

FIG. 7 shows a structural example of the task storage table 20 in the case of this structural example.

The user identification information and present information relating to the availability of a task corresponding to the user identification information are described in the task storage table 20. The task availability information is updated by the application processing unit 18 whenever necessary.

In the example of FIG. 7, although a numerical value is used as the user identification information, a character string such as a user name may also be used. In this case, coded data has only to be stored in the connection request packet.

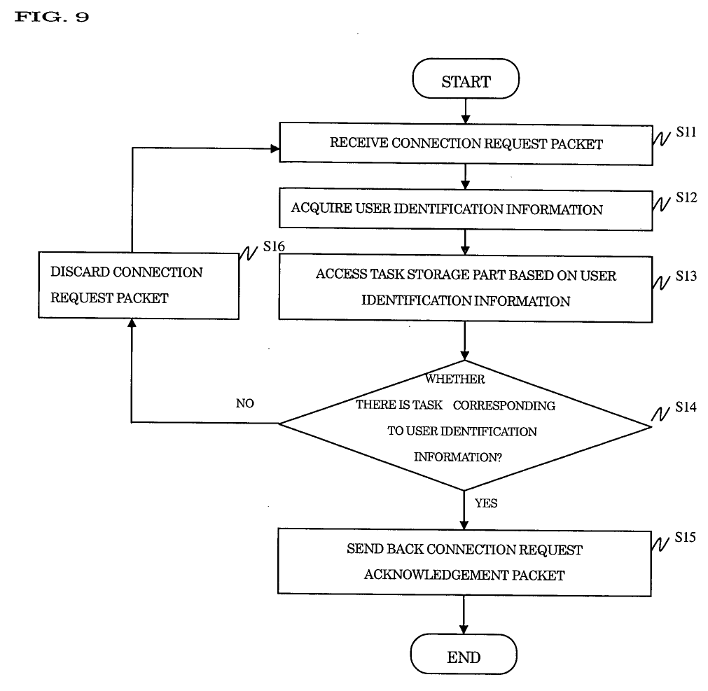

FIG. 8 shows an example of a processing procedure for the client computer 2 in the case of this structural example. FIG. 9 shows an example of a processing procedure for the server computer 1 in the case of this structural example.

First, the processing procedure for the client computer 2 of this structural example will be described with reference to FIG. 8.

When connecting to a server application on the server computer 1, the client computer 2 first acquires the user identification information corresponding to the user requesting the connection. The client computer 2 acquires this user identification information from the client application processing unit 25 (step S1).

Next, the client computer 2 uses the connection request packet generator 21 to generate the connection request packet. This packet stores the user identification information. The method for storing the information is obtained by referring to the storage rule table 26 (step S2).

In this case, as described above, various methods are conceivable as the storage rule described in the storage rule table 26. There is a storage rule previously shared between the server computer 1 and the client computer 2, and the user identification information has only to be stored in the connection request packet based on the rule. As described above, when the storage rule itself is shared with the server computer 1, it may be specific to each application, each client, each user's identification information or the like. Moreover, it is not always necessary to store the user identification information itself in the connection request packet and to transmit it. The user identification information may be converted into different information based on the conversion rule shared between the client computer 2 and the server computer 1, and the information may be stored in the connection request packet. As a result, packaging of the user identification information in the connection request packet can be done in a way which requires less processing by the connection request packet generator 21 and the identification information acquisition unit 13. This also allows for consistency with an existing network infrastructure.

Next, the client computer 2 transmits the generated connection request packet to the server computer 1 by the transmission unit 22 (step S3). The connection request packet contains the user identification information, as discussed above. Depending on the method by which the user identification information is stored into the connection request packet, multiple connection request packets may be used and transmitted.

The client computer 2 confirms that all connection request packets are transmitted, and waits for the connection request acknowledgement packet from the server computer 1 (step S4).

The client computer 2 judges whether or not there has been a response from the server computer 1 (step S5). If there is no response, the client computer 2 determines that the task does not exist on the server computer 1 and it is unnecessary to establish a connection, and the processing is ended.

If the client does receive the connection request acknowledgement packet from the server computer 1, the client computer 2 transmits the response acknowledgement packet thereto (step S6). This means that the task for the user requesting the connection is available on server computer 1. Thus, it is possible to prevent a useless TCP connection from being established, because the connection is only established if the task is available.

If multiple connection request packets are transmitted at step S3, and a connection request acknowledgement packet is received for any one of the request packets, the connection is established.

Alternately, the client computer 2 waits for the response to the connection request packet. If there is no response, the connection establishment is abandoned. Or a response packet can be received even if there is no available task. The lack of an available task can be indicated by, for example, an RST packet or a FIN packet. This allows the client computer 2 to confirm that the connection request packet was received by the server, even though a connection has not been established.

Next, an example of a processing procedure of the server computer 1 for this structural example will be described with reference to FIG. 9.

When receiving a packet by the reception unit 11, the server computer 1 uses the judgment unit 12 to evaluate the received packet. The server computer 1 confirms that the received packet is a connection request packet, and its destination port number is that of the server application executing in the application processing unit 18 (step S11).

Next, the server computer 1 uses the identification information acquisition unit 13, which refers to the acquisition rule table 19. Here the identification information acquisition unit 13 gets the rule for storage of the user identification information. This rule is shared with client computer 2. With the rule, the user identification information is acquired from the received connection request packet (step S12).

In the case of a storage rule where the user identification information is stored in multiple connection request packets is used, the server computer 1 waits to receive all of the connection request packets. The server computer 1 can determine that the connection request packets originate from the same user requesting the connection by using, for example, a common field value (for example, an IP address, a port number or the like) in the connection request packets.

Next, the task information acquisition unit 14 searches the storage table 20 using the user identification information acquired at step S12. In this way the server computer 1 confirms the availability of a task for this user identification information (step S13). The availability of a present task corresponding to the user identification information in the application processing unit 18 is stored in the task storage table 20. The information in the task storage table 20 is maintained by the application processing unit 18.

The availability of a task corresponding to the user requesting the connection identified by the user identification information is determined (step S14). If the task does not exist, the connection request packet is discarded (step S16), and the server waits for the next request.

If the task exists, a connection request acknowledgement packet corresponding to the received connection request packet is transmitted (step S15).

If the user identification information is stored in multiple connection request packets, the connection request acknowledgement packet is generated and transmitted in response to at least one connection request packet.

If the task does not exist, the connection request packet is discarded. Instead, however, an FIN packet or an RST packet can be transmitted as a response packet indicating that the task does not exist, and it may be explicitly notified to the client computer 2 that the task does not exist. By doing so, the client computer 2 can be certain to know the availability of the task in the server computer 1.

Even if the existence of the task corresponding to the user identification information can not be confirmed, the decision at step S14 can be suspended for a definite time. The task storage table during that time is monitored for changes, and when there is a change (a task is registered), the response that there is a task may be made. Thus, the frequency of inquiry from the client computer 2 can be reduced.

As described above, according to this structural example, the establishment of connections can be performed depending upon the availability of a task in the task storage table 20, and the establishment of an unnecessary TCP connection can be prevented. In this way, the security of the server computer 1 can be improved.

(Second System Structural Example)

Next, a description will be given of a structural example in which when a response method to a connection request packet is determined, and reference is made also to a server connection establishment policy stored in server computer 1.

In this structural example, a server policy storage table (not shown)is added to the structure of FIG. 6, and may be included in the result judgment unit 15.

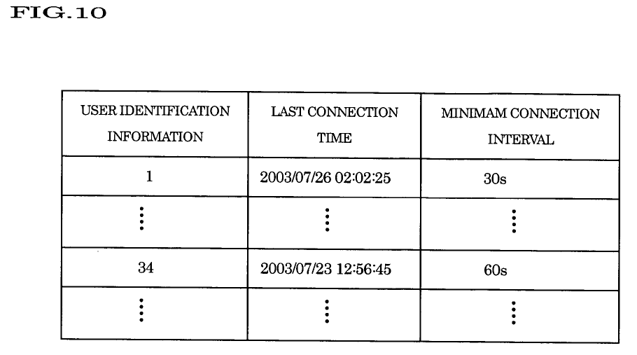

FIG. 10 shows a structural example of the server policy storage table.

Server policy information (hereinafter referred to as server policies) and user identification information are described in the server policy storage table. The server policies relate to permitting connections to users. The server policies are appropriately set at the server side by, for example, an administrator.

FIG. 10 contains an example server policy storage table. The table contains the most recent connection time for each user's identification information, and a minimum time (minimum connection interval) needed before a reconnection can be established by a connection request packet with the same user identification information. Other examples of connection permission policy parameters include, for example, a maximum number of connections from the user requesting the connection of the user identification information, a time period when the connection request is performed, and the determination of the propriety of a connection establishment according to the load status of the server computer 1.

A different server policy may be adopted for each user's identification information, or the server policy can be fixed to only one type of policy (for example, the method of FIG. 10). Alternately, a specified parameter in the server policy (for example, in the case of the example of FIG. 10, the minimum connection interval) may be set for each user's identification information.

Alternately, the server policy may be specific to each application, specific to each application group including one or more applications, specific to each client, specific to each client group including one or more clients, specific to each user identification information, or specific to each user identification information group including one or more user identification information.

For example, multiple user identification information can be combined into one group, and a policy for the group can be used. In this case, a table indicating the correspondence between the user's identification information and the group identification information would also be provided in the server computer 1. The group identification information is determined based on the user identification information. Thus, reference would only be made to the connection permission policy of the server as applied to the group.

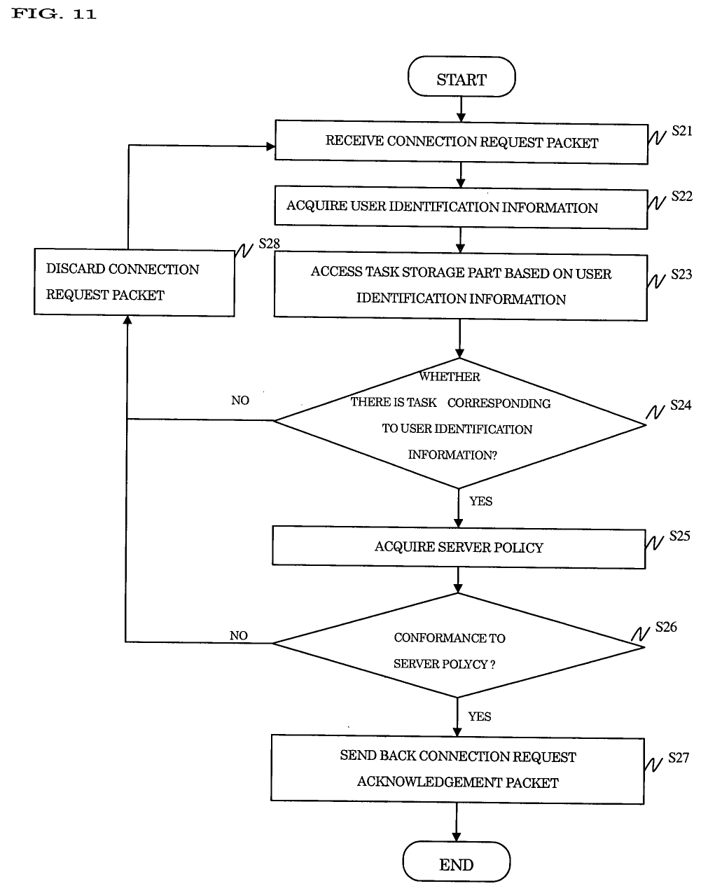

FIG. 11 shows an example of a processing procedure of the server computer 1 for this structural example.

When the server computer 1 receives a packet by the reception unit 11, the server computer 1 uses the judgment unit 12 to evaluate the received packet. The judgment unit 12 confirms that the received packet is a connection request packet and its destination port number is that of the server application executing in the application processing unit 18 (step S21).

Next, the identification information acquisition unit 13 refers to the acquisition rule table 19, and acquires the user identification information from the received connection request packet (step S22). This acquisition may be performed similarly to the first system structural example.

Next, the task information acquisition unit 14 determines the availability of a task corresponding to the user identification information acquired at step S22 (by searching the task storage table 20) (step S23). The availability of a present task corresponding to the user identification information in the application processing unit 18 is maintained in the task storage table 20.

A determination is made as to the availability of a task for the user requesting the connection as identified by the user identification information (step S24). If the task does not exist, the connection request packet is discarded (step S28), and the server computer 1 waits for another request.

If a task is available at step 24, the server policy is acquired from the server policy storage table based on the user identification information (step S25).

Then, the result judgment unit 15 determines if the connection request is allowed according to the server policy (step S26).

Here, as an example, it is assumed that the server policy requires the user requesting the connection to wait, for example, 30 seconds, between connections. In this case, when there is a connection established, the server computer 1 stores the connection request time corresponding to the user identification in the server policy storage table. When a new connection request occurs, the server determines the time elapsed between the time recorded in the table and the time of the connection request. If the elapsed time exceeds the minimum specified in the table for the user identification information, the connection is allowed.

It is not necessary that the last connection time is recorded in the server policy storage table, as that time may be recorded in another arbitrary table.

If the connection request conforms to the server policy (in the example, enough time has passed since the last connection), the connection request acknowledgement packet is transmitted in response to the received connection request packet (step S27).

If a task is not available, the connection request packet is discarded (step S28), and the server waits for another connection request.

In the above example, first, the decision to make the connection is based on the availability of the task, and next, the decision to make the connection is made based on the policy. However, the decision based on the policy can be made first, or the decisions may also be performed in parallel.

If the connection request packet is discarded, an FIN packet or an RST packet may be transmitted to explicitly notify the client computer 2 that the connection is refused. The reason why the connection is refused (for example, a task does not exist, or nonconformance to the policy) may be described in the packet.

Although in the example above, the elapsed time from the last connection time is used as the policy of the server computer 1, the policy may be based on the number of possible connections per unit time, the maximum number of connections which can be established simultaneously, or a restriction by a processing load (for example, CPU utilization ratio, memory utilization ratios or the like) of the server computer 1 at the time of the connection establishment. Thus, the connection establishment control is performed not only according to the availability of a task in the application processing unit 18, but also according to whether the connection establishment request conforms to the connection permission policy of the server computer 1. The connection permission policy corresponds to the user identification information.

According to this structural example, the control of the connection establishment can be performed according to the policy of the server computer 1 itself. It is thus possible to prevent the problem of overuse of the resource of the server computer 1 by some normal users. By this, the safety of the server computer 1 can be further improved.

(Third System Structural Example)

Next, a description will be given of a structural example in which when a response method to a connection request packet is determined, reference is made also to a connection establishment policy. This policy is previously registered in the server computer 1 by the user requesting the connection of the client computer 2.

In this structural example, a client policy storage table (not shown) is added. The client policy storage table may be included in the result judgment unit 15.

A structural example of the client policy storage table is similar to the server policy storage table of FIG. 10.

Client policy information (hereinafter referred to as client policy) for the user requesting the connection is described in the client policy storage table. The user requesting the connection is identified by the user identification information. In the client policy storage table, the user identification information corresponds to a client policy.

The content of the client policy is shared beforehand with the server computer 1, and the server computer 1 holds the client policy storage table. For example, the policy information can be sent from the client computer 2 through the network 3 to the server computer 1 and may be automatically set in the server. Alternately, the policy information can be given from each user to the administrator of the server computer 1, and the administrator may set the policy based on this information.

In the example of FIG. 10 as the client policy storage table, the last connection time for each user's identification information is stored. Additionally, a minimum time (minimum connection interval) needed before a reconnection can be established for the user identification information is held in the client policy storage table.

Examples of other client policies include limiting the number of connection requests performed simultaneously, or limiting the period of time in which the connection request is performed. This helps to protect against an attacker who attacks the server computer 1 using user identification information. With this client policy information, it is possible to reduce the influence of the attack or to protect against the attack.

A different client policy may be adopted for each user's identification information, or the client policy can be fixed to only a specific method(for example, the method of FIG. 10). A specified parameter (for example, in the case of the example of FIG. 10, the minimum connection interval) in the client policy may be set for each user's identification information.

The client policy may be specific to each application, specific to each application group including one or many applications, specific to each client, specific to each client group including one or more clients, specific to each user identification information, or specific to each user identification information group including one or more users' identification information.

For example, in a manner similar to the foregoing, multiple users' identification information is combined into one group, and a policy can be used for the whole group.

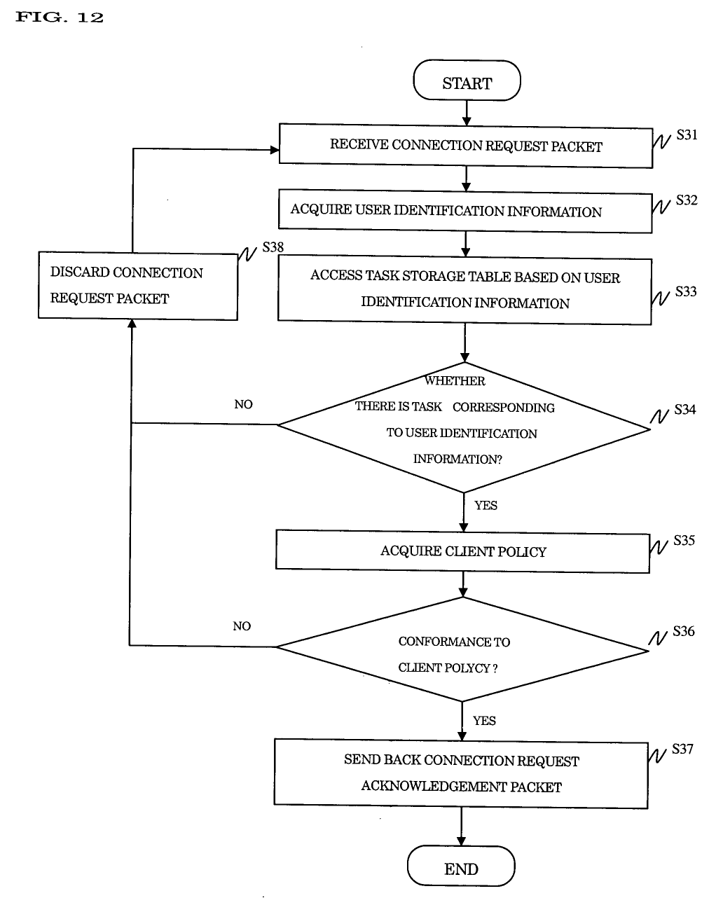

FIG. 12 shows an example of a processing procedure of the server computer 1 for this structural example.

When the server computer 1 receives a packet by the reception unit 11, the server computer 1 uses the judgment unit 12 to evaluate the received packet. The judgment unit 12 confirms that the received packet is a connection request packet, and its destination port number is that of the server application executing in the application processing unit 18 (step S31).

Next, identification information acquisition unit 13 refers to the acquisition rule table 19, and acquires the user identification information from the received connection request packet. Now the server has the user identification information available (step S32). The acquisition may be performed similarly to the first system structural example.

Next, the server computer 1 confirms the availability of a task corresponding to the user identification information means of the task information acquisition unit 14 searching the task storage table 20 (step S33). The availability of the present task corresponding to the user identification information is stored in the task storage table 20.

A judgment is made as to the availability of a task for the user requesting the connection(step S34). If the task is not available, the connection request packet is discarded (step S38), and the server waits for another request.

In the case where the task is available at step S34, the client policy is acquired from the client policy storage table based on the user identification information included in the connection request packet (step S35).

The result judgment unit 15 evaluates conformance with the server policy (step S36).

Here, as an example, it is assumed that the client policy requires the user requesting the connection to wait, for example, 30 seconds, between connections.

In this case, when there is a connection establishment request and the user identification information is confirmed, the server computer 1 records the time in the client policy storage table. When a new connection request occurs with the same user identification information, the server computer 1 determines the elapsed time between the current request and the previous time entered in the table. If the elapsed time is greater than the minimum time specified in the table, the connection is allowed.

It is not necessary that the last connection time is recorded in the client policy storage table, and it may be recorded in another arbitrary table.

If the connection request conforms to the client policy (in the example, in the case where the minimum elapsed time has passed), the connection request acknowledgement packet is transmitted in response to the received connection request packet (step S37).

On the other hand, if the task does not exist, the connection request packet is discarded (step S38), and the server waits for another request.

In the example above, first, the judgment as to whether or not to make the connection is made based on the availability of the task, and next, the judgment as to whether or not to make the connection is made based on the policy. Alternately, the judgment based on the policy can be made first, or both the judgments may be performed in parallel.

Alternately, if the connection request packet is discarded, an FIN packet or an RST packet may be transmitted to explicitly notify the client computer 2 that the task is not available. The reason why the connection request packet is discarded (for example, the task does not exist, or nonconformance to the policy) may be described in the packet.

Although the elapsed time from the last connection time is used as the policy in the example above, other policies can be used. The policy may be based on the number of possible connections per unit time, the maximum number of connections which can be established simultaneously, or a restriction by the processing load (for example, CPU utilization ratio, memory utilization ratios or the like) on the server computer 1 at the time of the connection establishment. The connection establishment control is performed not only according to the availability of the task in the application processing unit 18, but also according to whether the connection establishment request conforms to the client policy. This policy is previously notified to the server computer 1 by the user requesting the connection that corresponds to the user identification information in the application processing unit 18.

According to this structural example, it is possible to reduce the vulnerability of the server computer 1 to an attacker that uses the user identification information to establish a connection. In this way, the security of the server computer 1 can be further improved.

By combining this system structural example with the second embodiment, connections can be enabled only in the case where both the server policy of the server computer 1 and the client policy of the client computer 2 are satisfied. In the case where the server policy and the client policy conflict with each other, either one of the policies may be enforced. For example, priority may be given to either the server policy of server computer 1, or the client policy of client computer 2. Alternately, if the server policy and the client policy conflict with each other, the connection can be refused. Other variations based on combining client and server policies are possible.

(Fourth System Structural Example)

Next, a description will be given of a structural example where a user requesting the connection of the client computer 2 stores the user identification information and the “user operation mode information” into a connection request packet. This information is based on a predetermined response method. The connection establishment policy in this example corresponds to the user operation mode information.

In this structural example, the result judgment unit 15 refers to a policy storage unit, provided as a user operation mode policy storage table (not shown) which may be included in the result judgment unit 15.

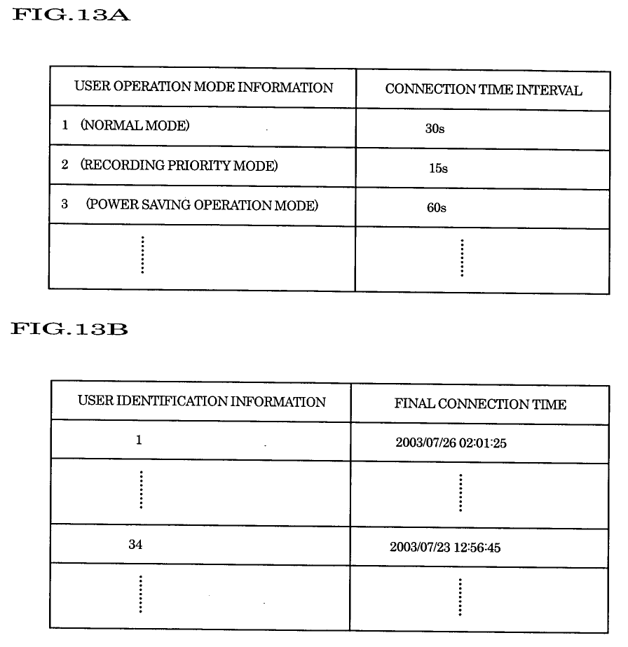

FIG. 13A shows a structural example of the user operation mode policy storage table. FIG. 13B shows an example of the structure of the task storage table 20 in this system structural example.

The user operation mode policy storage table contains both user operation mode information and “policy information”. “Policy information” is information describing policy parameters for a given mode. “User operation mode information” is information indicating the execution state of the client computer 2 for the user requesting the connection or client application operating on the client computer 2. This “user operation mode information” includes, for example, information such as “normal mode”, “recording priority mode”, “power saving operation mode” or “suspension state”. These user operation modes change the way a connection is requested for a given user requesting the connection.

One way to use the user operation mode is to vary the time interval between connection requests. For example, the time interval between connection requests can be lengthened when in power save mode, thus decreasing the frequency of connection requests. FIG. 13A shows an example in which the policy information (in this case, the minimum connection interval) changes between “normal mode”, “recording priority mode” and “power saving operation mode”. Numerous variations are possible, such as changing the maximum number of simultaneous connection requests and changing the time period when the connection request is performed.

Using this information, the server computer 1 determines the distribution and schedule of the resource corresponding to the state of the user requesting the connection.

It is assumed that the user operation mode information and the policy information are previously shared with the server computer 1. For example, the user operation mode information and the policy information can be sent from the client computer 2 through the network 3 to the server computer 1 and may be automatically set in the server computer 1. Alternately, each user may notify the administrator of the server computer 1, and the administrator may then set the information in the server computer 1.

Different user operation mode policies may be adopted for each user's identification information, or the policy may be fixed (for example, the method of FIGS. 13A and 13B). In either case a specified parameter (for example, in the case of the example of FIGS. 13A and 13B, the minimum connection interval) in the user operation policy may be set for each user's identification information.

The user operation mode information and the policy information may be specific to each application, specific to each application group including one or more applications, specific to each client, specific to each client group including one or more clients, specific to each user's identification information, or specific to each user identification information group including one or more user identification information.

The user identification information, the availability of the task, and the last connection time are described in the task storage table 20. In FIG. 13B, the availability of the task is omitted from the table.

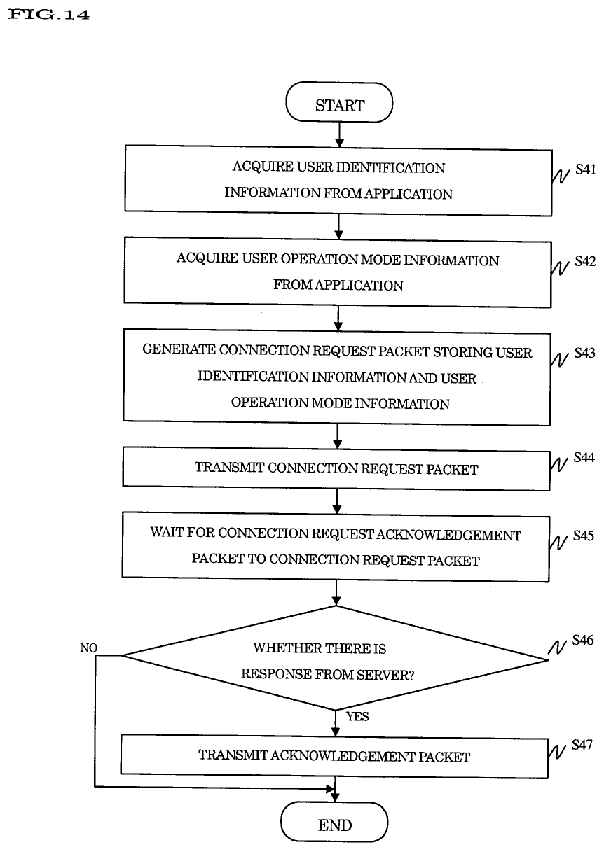

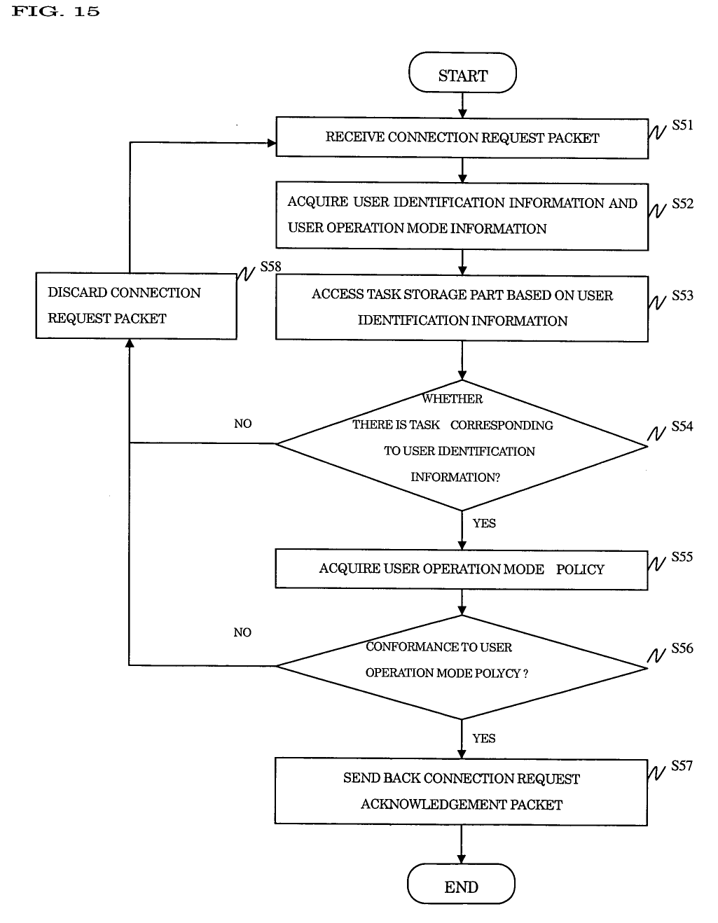

FIG. 14 shows an example of a processing procedure by the client computer 2 for this structural example. FIG. 15 shows an example of a processing procedure by the server computer 1 for this structural example.

The processing procedure of client computer 2 will be described first, with reference to FIG. 14.

In order to connect to a server application of the server computer 1, the client computer 2 must first obtain the user identification information of the user requesting the connection. The client gets this information from the client application processing unit 25 (step S41).

Next, the client computer 2 acquires user operation mode information indicating the operating mode of the application from the client application processing unit 25 (step S42).

Next, the client computer 2 generates the connection request packet. The packet is generated by the connection request packet generator 21, and stores the user identification information and the user operation mode information. The user identification information and the user operation mode information are stored according to the storage rule table 26 (step S43).

In this example, storage of both the user identification information and the user operation mode information is described in the storage rule table 26. The storage rules for the user operation mode information are similar to those described earlier for the storage of the user identification information.

Next, the client computer 2 transmits the connection request packet to the server computer 1 by the transmission unit 22 (step S44). Depending upon the storage method of the user identification information into the connection request packet, there may be multiple connection request packets transmitted.

After confirming that all connection request packets have been transmitted, the client computer 2 waits for the connection request acknowledgement packet from the server computer 1 (step S45).

The client computer 2 determines whether the response from the server computer 1 has occurred (step S46). If there is no response, the client determines that the task does not exist. Thus it is unnecessary to establish a connection, and the client processing is completed.

If the client computer 2 receives the connection request acknowledgement packet from the server computer 1 in response to the connection request packet, the client computer 2 transmits a response acknowledgement packet to the server (step S47).

If, at step S44, multiple connection request packets are transmitted, the client establishes the connection upon receiving a connection request acknowledgement packet for any one of the request packets it has sent.

In the example above, the client computer 2 waits for a response to the connection request packet. If there is no response, connection establishment is abandoned. Alternately, the server computer 1 may send, for example, an RST packet, an FIN packet or the like as a response packet to indicate the task is not available.

Next, the processing procedure of the server computer 1 for this structural example will be described, with reference to FIG. 15.

The server computer 1 receives the packet with the reception unit 11. The server computer 1 then uses the judgment unit 12 to evaluate the received packet. In this way the server computer 1 determines whether the received packet is a connection request packet, and if its destination port number is that of the server application executed in the application processing unit 18 (step S51).

Next, the identification information acquisition unit 13 refers to the acquisition rule table 19, and acquires the user identification information and the user operation mode information from the received connection request packet (step S52).

In this case, storage rules for both the user identification information and the user operation mode information are described in the acquisition rule table 19. The storage rules for the user operation mode information are similar to those described earlier for the storage of the user identification information.

Using the rule shared with the client computer 2, the server computer 1 restores the user operation mode and user identification information. In the event that multiple packets are used to store the information, the server waits for all the packets to be received before restoring the data.

Next, the server computer 1 uses the user identification information acquired at step S52 to search the task storage table 20 with the task information acquisition unit 14 (step S53). The present availability of a task corresponding to the user identification information is maintained in the task storage table 20.

Using the information acquired at S53, the server computer 1 determines the availability of a task corresponding to the user identification information (step S54). If a task is not available, the connection request packet is discarded (step S58), and the server computer 1 waits for another request.

If the task is available, the server computer 1 searches the user operation mode policy storage table with the user operation mode information. In this way the server computer 1 determines the user operation mode policy for this operation mode (step S55).

The result judgment unit 15 evaluates conformity with the server policy (step S56).

Here, as an example, assume the user requesting the connection is in the power saving state (operation mode information: 3). This information is obtained from the operation mode information sent by the client computer 2 (see FIG. 13A). In this case, the request to establish a connection is transmitted at intervals of 60 seconds, which is twice the interval of the normal mode (operation mode information: 1).

When there is a connection establishment request, and the user identification information is confirmed, the server computer 1 records this time in the task storage table 20. The entry in the task storage table maps the user identification information to the last connection request time. When a new connection request occurs, the server computer 1 determines the previous connection time for this user identification information. If the time exceeds 60 seconds, the connection request is allowable.

It is not necessary that the last connection request time be recorded in the task storage table. This information can be recorded in another arbitrary table.

In this example, using the power saving mode, the request interval of the connection establishment is increased. However, it is also possible to shorten the connection request interval using an operation mode, such as an enhanced mode, in which priority is given to processing speed.

If the request satisfies the constraints of the policy information (in this example, in the case where the required time interval has passed), the connection request acknowledgement packet is transmitted in response to the received connection request packet (step S57).

If the task is not available, the connection request packet is discarded (step S58), and the server waits for another request.

In the example above, the decision to make a connection is first based on the task availability, and then on the policy. Alternately, the decision based on the policy can be made first, or both decisions can be made in parallel.

If the connection is refused, the server computer 1 can send a response indicating that a task is not available. For example an FIN packet or an RST packet may be transmitted to explicitly notify the client computer 2 that a task is not available. In addition, the reason why the connection has been refused (for example, the task does not exist, or nonconformance to the policy) may be described in the packet.

In the above example, the policy information is a minimum interval between connection times. Alternately, this information could be the number of possible connections per unit of time, the maximum number of connections which can be established simultaneously, or a restriction based on a processing load (for example, CPU utilization ratio, memory utilization ratios, or the like) of the server computer 1 at the time of the connection establishment. The connection establishment control may be based not only on the availability of the task in the application processing unit 18, but also based on whether the connection establishment request conforms to the policy information. This policy information corresponds to the user operation mode of the client computer 2.

If the rule for storing the user identification information into the connection request packet is fixed to a single rule, the storage rule table entry for the user identification information can be omitted. Similarly, if the rule for storing the policy information into the connection request packet is fixed to a single one, the storage rule table entry for the policy information can be omitted.

By this structural example, the decision for whether to establish a connection can be made based not only the availability of the task, but also the operative state of the client computer 2. In this way, the server computer 1 can offer more effective confirmation of task availability to the client computer 2. Using this method, the number of unnecessary connections can be further decreased, and the security of the server computer 1 can be further improved.

This system structural example may be combined with the second embodiment, the third embodiment, or both the second embodiment and the third embodiment.

The respective functions are described as software, and their utility can be realized by having a suitable computer perform the functions.

Additionally, this embodiment can be carried out as a program to cause a computer to execute a specified procedure, or to cause a computer to function as a specified unit, or to cause a computer to achieve a specified function. In addition, it can be carried out as a computer readable medium which contains the program.

The invention is not directly limited to these embodiments. The structural elements may be modified and the invention may be practiced in various ways without departing from the scope of the invention. Additionally, variations can be formed by combining the multiple structural elements disclosed in the embodiment. For example, some elements may be deleted from all the structural elements disclosed in the embodiment. Further, structural elements from the different embodiments may be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A server apparatus comprising:
a processor configured to execute a task for providing a service to a client apparatus through a connection established on a network;
a storage unit configured to store task information which indicates the availability of a task to be executed by the processor, corresponding to user identification information relating to the client apparatus;
a reception unit configured to receive a connection request packet from the client apparatus;
a first acquisition unit configured to acquire the user identification information from the received connection request packet;
a second acquisition unit configured to acquire the task information in the storage unit based on the acquired user identification information;
a determination unit configured to determine, based on at least the acquired task information, whether a connection request by the connection request packet is allowed; and
a transmission unit to transmit a packet to establish the connection in a case where it is determined that the connection request is allowed.

2. The server apparatus according to claim 1, further comprising a storage rule table configured to describe a storage rule of the user identification information in the connection request packet,
wherein the first acquisition unit is configured to acquire the user identification information from the received connection request packet according to the storage rule table.

3. The server apparatus according to claim 1, wherein the packet to establish the connection is an acknowledgement packet.

4. The server apparatus according to claim 1, wherein the transmission unit is configured to transmit a packet to establish the connection when the acquired task information indicates the task to be executed is available.

5. The server apparatus according to claim 1, further comprising:
a policy storage unit configured to store policy information defined by other information exclusive of the task information in the connection request packet; and
a third acquisition unit configured to acquire the other information from the received connection request packet;
wherein the transmission unit is configured to transmit a packet to establish the connection when the acquired task information indicates the task to be executed is available and when the acquired other information matches the policy information corresponding to the user identification information in the policy storage unit.

6. The server apparatus according to claim 5, the policy information includes server policy information related to server apparatus or client policy information related to client apparatus.

7. The server apparatus according to claim 1, further comprising:
a policy storage unit configured to store policy information defined by other information exclusive of the task information in the connection request packet and by mode information indicating a condition of the client apparatus or a client application on the client apparatus related to the user identification information; and
a third acquisition unit configured to acquire the mode information from the received connection request packet;
wherein the transmission unit is configured to transmit a packet to establish the connection when the acquired task information indicates the task to be executed is available and when the acquired other information and the mode information match the policy information corresponding to the user identification information in the policy storage unit.

8. The server apparatus according to claim 7, further comprising a storage rule table configured to describe a storage rule of the mode information in the connection request packet,
wherein the third acquisition unit is configured to acquire the mode information from the received connection request packet according to the storage rule table.

9. A server operating method, comprising:
executing a task for providing a service to a client apparatus through a connection established on a network;
storing in a storage unit mask information which indicates the availability of a task to be executed corresponding to user identification information relating to the client apparatus;
receiving a connection request packet from the client apparatus;
acquiring the user identification information from the received connection request packet;
acquiring the task information in the storage unit based on the acquired user identification information;
determining, based on at least the acquired task information, whether a connection request by the connection request packet is allowed; and
transmitting a packet to establish the connection in a case where it is determined that the connection request is allowed.

10. The server operating method according to claim 9, further comprising configuring a storage table to describe a storage rule of the user identification information in the connection request packet,
wherein acquiring the user identification information includes acquiring the user identification information from the received connection request packet according to the storage rule table.

11. The server operating method according to claim 9, wherein transmitting the packet includes transmitting an acknowledgement packet.

12. The server operating method according to claim 9, wherein transmitting the packet includes transmitting the packet to establish the connection when the acquired task information indicates the task to be executed is available.

13. The server operating method according to claim 9, further comprising:
storing, in a policy storage unit, policy information defined by other information exclusive of the task information in the connection request packet; and
acquiring the other information from the received connection request packet; wherein transmitting the packet includes transmitting the packet to establish the connection when the acquired task information indicates the task to be executed is available and when the acquired other information matches the policy information corresponding to the user identification information in the policy storage unit.

14. The server operating method according to claim 13, wherein storing policy information includes providing the policy information to include server policy information related to server apparatus or client policy information related to client apparatus.

15. The server operating method according to claim 9, further comprising:
storing, in a policy storage unit, policy information defined by other information exclusive of the task information in the connection request packet and by mode information indicating a condition of the client apparatus or a client application on the client apparatus related to the user identification information; and
acquiring the mode information from the received connection request packet;
wherein transmitting the packet includes transmitting the packet to establish the connection when the acquired task information indicates the task to be executed is available and when the acquired other information and the mode information match the policy information corresponding to the user identification information in the policy storage unit.

16. The server operating method according to claim 15, further comprising configuring a storage rule table to describe a storage rule of the mode information in the connection request packet;
wherein acquiring the mode information includes acquiring the mode information from the received connection request packet according to the storage rule table.

17. A computer program computed on a server apparatus, the computer program having a plurality of instructions that cause a processor to perform the following steps:
executing a task for providing a service to a client apparatus through a connection established on a network;
storing in a storage unit mask information which indicates the availability of a task to be executed corresponding to user identification information relating to the client apparatus;
receiving a connection request packet from the client apparatus;
acquiring the user identification information from the received connection request packet;
acquiring the task information in the storage unit based on the acquired user identification information;
determining, based on at least the acquired task information, whether a connection request by the connection request packet is allowed; and
transmitting a packet to establish the connection in a case where it is determined that the connection request is allowed.

18. The computer program of claim 17,
further comprising the step of configuring a storage table to describe a storage rule of the user identification information in the connection request packet,
wherein the step of acquiring the user identification information includes acquiring the user identification information from the received connection request packet according to the storage rule table.

19. The computer program of claim 17, wherein the step of transmitting the packet includes transmitting an acknowledgement packet.

20. The computer program of claim 17, wherein the step of transmitting the packet includes transmitting the packet to establish the connection when the acquired task information indicates the task to be executed is available.
